(19) United States
(12) Patent Application Publication
(10) Pub. No.: US 2022/0078598 A1
(43) Pub. Date: Mar. 10, 2022

(54) PWS-ENHANCEMENTS FOR NON-3GPP DEVICES

(71) Applicant: IPCom GmbH & Co. KG, Pullach (DE)

(72) Inventors: Andreas SCHMIDT, Braunschweig (DE); Achim LUFT, Braunschweig (DE); Maik BIENAS, Schöppenstedt (DE); Martin HANS, Bad Salzdetfurth (DE)

(73) Assignee: IPCom GmbH & Co. KG, Pullach (DE)

(21) Appl. No.: 17/417,772

(22) PCT Filed: Feb. 18, 2020
(86) PCT No.: PCT/EP2020/054227

§ 371 Date: Jun. 24, 2021

(30) Foreign Application Priority Data
Feb. 18, 2019 (EP) 19157693.3

(51) Int. Cl. H04W 4/90; H04W 4/021; H04W 4/06

(52) U.S. Cl. CPC H04W 4/90; H04W 84/042; H04W 4/06; H04W 4/021

(57) ABSTRACT

The present invention provides a method of distributing public warning messages to a subscriber of a cellular communications system, the method comprising storing in a database information connecting a cellular device of the subscriber to at least one messaging service receivable by a device other than the cellular device; and in the event that a public warning message is to be broadcast to an area in which the cellular device of the subscriber is located, transmitting a warning message to the subscriber using the at least one messaging service to the device other than the cellular device.

The present invention relates to the transmission of public warning messages.

3GPP networks support the public warning system (PWS) which is used to alert the public to events such as disasters. For instance, when earthquakes, tsunamis, hurricanes, volcanic eruptions, wild fires (or similar emergency situations) occur, the PWS may be used to notify people to leave the impacted area within a certain time. As such, dissemination of PWS notifications is usually restricted to a certain region. In case of emergency, PWS messages may be originated by the authorities of a country or district.

Different countries have different requirements on the delivery of warning messages and 3GPP networks support different warning systems for different countries. However, the warning systems supported by 3GPP use a common system architecture and common signalling procedures. That means, PWS messages are originated from a cell broadcast entity (CBE, for example, an entity under control of an authority, such as a meteorological or geological agency, and alike) via a cell broadcast centre (CBC, for example, an entity associated with the mobile network operator's (MNO's) core network), which acts as the information distribution server. From there the PWS messages are propagated only to relevant base stations (deployed in the area where the disaster occurred) of the cellular communication network. The last hop is from the base station(s) to the mobile terminals (UEs) over the air in broadcast mode. 3GPP standardized different warning systems in different releases, according to requests from corresponding countries (cf. Table 1).

TABLE 1

| Warning | | 3GPP | |
|---|---|---|---|
| System | Target Region | Release | Remark |
| ETWS | Japan | Rel-8 | SIB-Type 10 (primary) and |
| | | | SIB-Type 11 (secondary) |
| CMAS | United States of | Rel-9 | SIB-Type 12 |
| | America | | |
| KPAS | South Korea | Rel-10 | Minor Variant of CMAS |
| EU-Alert | European Countries | Rel-11 | Minor Variant of CMAS |

The earthquake and tsunami warning system (ETWS) was the first warning system to be standardized in Rel-8 for Japan. The ETWS was designed based on Japanese requirements focusing on earthquakes and tsunamis. The concept of ETWS (and all subsequent warning systems) is very similar to cell broadcasting in WCDMA and GSM network. In WCDMA, a special channel called CTCH (common traffic channel) was used for this purpose, but in LTE a couple of system information broadcast (SIB) messages were defined to periodically broadcast the warning messages to all the UEs in a certain area simultaneously. Additionally, UEs in the respective areas can be instructed by a special Paging Message (parameter “ETWS notification” set to “true”) to read and decode the transmitted system information immediately. For example, in LTE, the SIBs carrying the information about ETWS are SIB10 (for the secondary notification) and SIB11 (for the primary notification). Thanks to the broadcast nature of PWS on the air interface the warning messages are not affected by network congestion, and they can be received by UEs residing in RRC_IDLE as well as UEs residing in RRC_CONNECTED mode of operation (if those UEs are able to pick up the respective downlink signals from a base station). The receipt of a broadcast message is usually not acknowledged by the receiving device.

Further details on how ETWS (and all subsequent PWS) work can for instance be found in NTT Docomo's Technology Report Vol. 11.3 under the following link:

https://www.nttdocomo.co.jp/english/binary/pdf/corporate/technology/rd/technical_journal/bn/vol11_3/vol11_3_020en.pdf

Currently, tablets and laptops (even if they have a 3GPP subscription) are not required to support rendering of PWS notifications. Support of the PWS feature is only required for mobile devices with a 3GPP subscription (user equipment, UEs) that do support voice functionality.

The terms “warning message(s)” “PWS notification(s)” and “PWS message(s)” are used interchangeably throughout this document and are meant to represent the same thing.

WO 2014/159519 A1 describes a warning messaging system in which a UE can receive a cellular network public warning message. The UE is also able to receive an alternate warning message over an alternate network, for example a home WLAN network by registering its last known cell via the alternate network. US 2009/0247111 A1 describes a system in which a mobile device can receive public warning messages via a cellular network or a wireless access point when the cellular connection is temporarily inoperative.

U.S. Pat. No. 9,992,333 B2 describes a technique for distributing emergency notification messages received from a client. A personal profile of the client is stored by a network and when the network receives an emergency notification from a device of the client, emergency notification messages are sent to contacts stored in the profile.

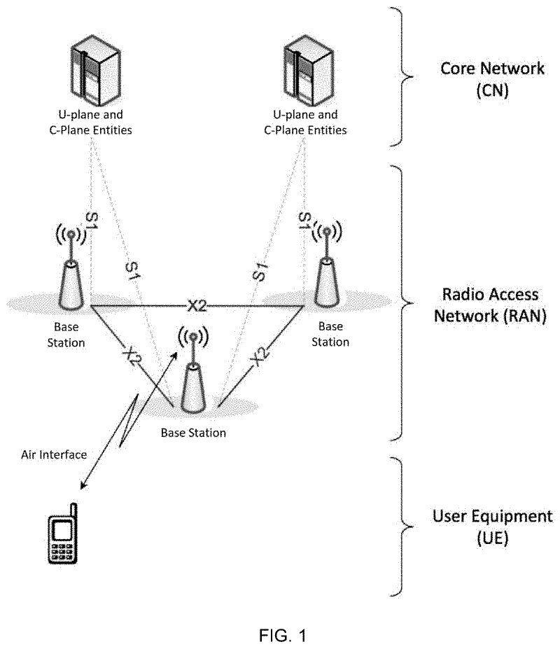

FIG. 1 shows the general architecture of a wireless communication system according to 3GPP. In case of LTE, the most important core network (CN) entities are the serving gateway (S-GW) for handling of user plane traffic and the mobility management entity (MME) for handling of control plane traffic.

The most relevant functions of the MME for the present invention are:
Reachability of UEs residing in RRC IDLE mode of operation
(including control and execution of the paging procedure);
Tracking area list (TAL) management; and
Support for PWS message transmission.

In LTE, the radio access network (RAN) is made up of 4G base stations (eNBs). Each eNB has its own S1 connection into the CN. The S1 interface supports a many-to-many relation between MMEs/S-GWs and eNBs. A base station may span multiple cells (or “coverage sectors”). Typically, up to three more or less equally distributed segments of circle are provided as coverage sectors by a single base station. In many deployment scenarios, these coverage sectors are roughly of the same width (i.e. with opening angles of approx. 120 degrees each).

The S1 connection can be logically subdivided into an S1-U connection for user plane traffic terminating at the S-GW and an S1-C connection for control plane traffic terminating at the MME. Furthermore, eNBs may be interconnected with one another over a (logical) X2 interface. Such X2 connections may physically go through the core network in some cases.

In case of LTE, the wireless interface between an eNB and a mobile terminal (user equipment, UE) is referred to as LTE Uu Interface.

The present invention is not restricted to wireless communication systems operating according to 3GPP's LTE suite of specifications (also known as 4G systems). Upcoming 5G wireless communication systems, such as the one developed by 3GPP in course of Rel-15, are explicitly included in the scope of the present invention.

PWS in 4G LTE was designed for sending instant emergency and disaster alerts to 4G mobile users. It accommodates the cell broadcast centre (CBC) and cell broadcast entity (CBE) that stem from the cell broadcast service (CBS) network architecture developed for pre-LTE radio communication systems, such as the global system for mobile communications (GSM) and the universal mobile telecommunication system (UMTS).

A warning message may include (among other information elements) a message identifier, a serial number, warning message contents and a digital coding scheme, and a digital signature.

On the infrastructure side, the warning messages are delivered from the CBE to the LTE base station (eNB) via the CBC and MME. The protocol used between the CBC and the MME is the SBc-AP, while the protocol used between the MME and the (at least one) LTE base station (eNB) is the S1AP. For the air interface, PWS uses different types of system information blocks such as SIB-Type10, SIB-Type11 and SIB-Type12 for message delivery (cf. Table 1).

The distribution areas for PWS can be specified in three different granularities allowing mobile network operators (MNOs) an efficient and flexible broadcast of the warning messages:

Cell Level Distribution Area

The CBC designates the cell-level distribution areas by sending a list of Cell-IDs. The emergency information is broadcast only in the designated cells.

TA Level Distribution Area

In this case, the distribution area is designated as a list of tracking area identities (TA-IDs). A TA-ID is an identifier of a tracking area (TA), which represents an LTE mobility management area. The warning message broadcast goes out to all of the cells in the TA-IDs.

EA Level Distribution Area

The emergency area (EA) can be freely defined by the MNO. An EA-ID can be assigned to each cell of the cellular communication system, and the warning message can be broadcasted to the relevant EA only. The EA can be larger than a cell and is independent of the TA concept. The EA thus allows a very flexible design for optimization of the distribution area for the affected area according to the type of disaster.

A figure illustrating the differences between these three distribution area granularities can also be found in NTT Docomo's Technology Report Vol. 11.3 under the link given above.

In case of a disaster or an imminent threat, the CBE may trigger emergency information distribution at the CBC. When the MME receives a Write-Replace Warning Request message from the CBC, it sends a Write-Replace Warning Confirm message back to the CBC to notify that the initial request message was correctly received. The CBC may then notify the CBE that the distribution request was correctly received, and that its processing in the mobile network operator (MNO) domain has begun. At the same time, the MME checks the distribution area information in the received message and, if a TA-ID list is included (cf. granularity #2 from the list above), it sends the Write-Replace Warning Request message only to those LTE base stations (eNBs) that belong to the TA-IDs in the list. If the TA-ID list is not included, the message is sent to all LTE base stations to which the MME is connected. When an eNB receives the Write-Replace Warning Request message from the MME, it determines the message distribution area based on the information included in the Write-Replace Warning Request message and starts the transmission of the message in broadcast mode in the relevant cells (cf. definition of “coverage sectors” in the text above). The following describes how the eNB processes each of the specified information elements:
1) disaster type information (message identifier/serial number)
If an on-going broadcast of a warning message exists, this information is used by the eNB to decide whether it shall discard the newly received message or overwrite the ongoing warning message broadcast with the newly received one. Specifically, if the received request message has the same type as the message currently being broadcast, the received request message is discarded. If the type is different from the message currently being broadcast, the received request message shall overwrite the ongoing broadcast message and the new warning message is immediately broadcast.
2) message distribution area (warning area list)
When a list of cells has been specified as the distribution area, the eNB scans the list for cells that it serves and starts warning message broadcast only in these cells. If the message distribution area is a list of TA-IDs, the eNB scans the list for TA-IDs that it serves and starts the broadcast to the cells included in those TA-IDs. In the same way, if the distribution area is specified as an EA (or list of EAs), the eNB scans the EA-ID list for EA-IDs that it serves and starts the broadcast to the cells included in the EA-ID list. If the received Write-Replace Warning Request message does not contain distribution area information, the eNB broadcasts the warning message to all of the cells it serves.

Communication via social networks and instant messaging services is ubiquitous and commonly used with all kinds of devices like e.g. PCs, smartTVs, or wearables. The PWS system is currently not prepared to interact with those third-party services and non-3GPP devices. Therefore, the 3GPP public warning system does not reach as many recipients as possible by addressing non-3GPP devices with this enhancement.

It is currently unclear if and how transmission of PWS messages to non-3GPP devices can be achieved with the current network architecture and signalling flow. The PWS enhancement will allow forwarding PWS notifications via instant messaging services and social networks to multiple non-3GPP user devices addressed by these services.

The present invention provides a method of distributing a public warning message to a subscriber of a cellular communications system, the method comprising determining a geographical location of a cellular device associated with a subscriber; storing in a database information connecting the cellular device associated with the subscriber to at least one messaging service receivable by a device other than the cellular device; and in the event that a public warning message is to be broadcast to the geographical location in which the cellular device of the subscriber is located, transmitting a warning message to the subscriber using the at least one messaging service to the device other than the cellular device.

This invention adapts 3GPP's public warning system in order to address a large amount of non-3GPP devices. In particular, aspects of the present invention enable:

PWS support for non-3GPP devices. A user can receive PWS notifications on a multitude of his devices; even devices without cellular modem or mobile phone subscription; e.g. smartTVs or wearables. A user registers alternative communication or messaging services such as social media accounts, identities or any non-3GPP communication address with his subscription to provide his MNO with means to provide alert messages via these accounts or addresses.

When an alert message according to the known public warning system feature in 3GPP needs to be sent out by an MNO, the MNO in parallel to broadcasting the alert messages according to PWS prior-art determines 3GPP devices registered or present in the respective alert area. From the subscriber related information of the determined devices, the registered alternative communication services are looked-up and an alert message is provided to these alternative communication services.

For this, at least one new look-up table (for example, in the form of a database) is introduced and administered in the MNO's core network domain. The input parameters which are needed to find out what alternative messaging services have been registered under the user's subscription for provisioning of PWS messages are taken from the user devices' current whereabouts in the system. The whereabouts information is based on the UEs registered in the distribution area of the alert message according to the three levels of distribution area granularity described above, i.e. cell-IDs, TA-IDs, or EA-IDs. The UEs' location is known to the core network at a cell level, TA-level or TA-list-level, dependent on each UE's current configuration and communication mode (e.g. Idle or Connected). The MNO determines UEs to be alerted based on an overlap of the alert message distribution area and the location area of the respective UEs as known to the network. In other words, if a registered UE is within the distribution area with high likelihood, then the subscriber of the UE is determined to be alerted and the respective subscription specific look-up table is further used by the core network.

The output parameters from the look-up table to address the subscriber's alternative non-3GPP IDs via alternative (third-party) messaging services is an alternative communication or messaging address information. This registered address (which may be an MNO internal subscriber ID) may for instance be an MSISDN (including MCC and MNC) not inherent to the subscription, i.e. an MSISDN or a different MNO or an IMSI or a similar identifier of a different device. The alternative address may also be a username for a messaging service. Also, multiple addresses for multiple different alternative messaging services may be registered with the subscriber.

First a subscriber is determined from the PWS notification area information (“Who has at least one UE in the affected tracking area?”), then the parameters for addressing further user IDs (non-3GPP) by interworking with third-party services (e.g. social networks or instant messaging services) are derived from the subscription (“Is the subscriber using other services and are these registered for propagation of PWS notifications?”). Copies of PWS notifications for a given user are then generated and submitted to the third-party service provider.

A particular aspect of a method of the present invention is
broadcasting by a network one or more messages in a pre-defined distribution area, and in parallel
determining which UEs are registered in a core network in a location that at least partly overlaps with the distribution area,
determining one or more subscribers associated with the determined UEs, looking-up by the network (e.g. in a subscriber data base) alternative communication addresses of the subscribers (the addresses not being alternative addresses of the determined UEs) in one or more alternative communication networks, and
providing the one or more messages addressed to the alternative communication addresses in the one or more alternative communication network for delivery to one or more further devices.

The further devices can be any devices able to communicate with the alternative communication network.

Optionally, copies of PWS notification may be amended before provisioning to the third-party for delivery via the alternative communication or messaging service, e.g. they may be marked as being warning messages for another device and/or another distribution area and/or that the current location of the receiving device does not necessarily fall into the PWS notification area.

The user is enabled to express propagation preferences for handling of PWS notifications. These preferences may be service specific and are ideally stored in the MNO core network domain. In one embodiment these preferences are stored in the same database.

Third-party services used for addressing non-3GPP devices could be, as an example but not as an exhaustive list, such services as social networks or instant messaging services or any combination out of several such services. It is to be recommended that before a PWS notification is forwarded to non-3GPP devices addressed via user identities allocated by the third-party service provider, the third-party service provider authenticates the MNO and authorizes forwarding the PWS notification on the basis of user consent and preferences given in the third-party service platform.

A solution for non-3GPP devices in the same local area network (LAN) as a notified UE is described in the third embodiment. This slightly different solution works without any third-party service. Also, the operator is not involved in this solution. On the other hand, this solution is strictly limited to devices connected to the same LAN.

Embodiments of the invention will now be described, by way of example only, with reference to the accompanying drawings in which:

FIG. 1 is a schematic representation of a mobile communications network; and

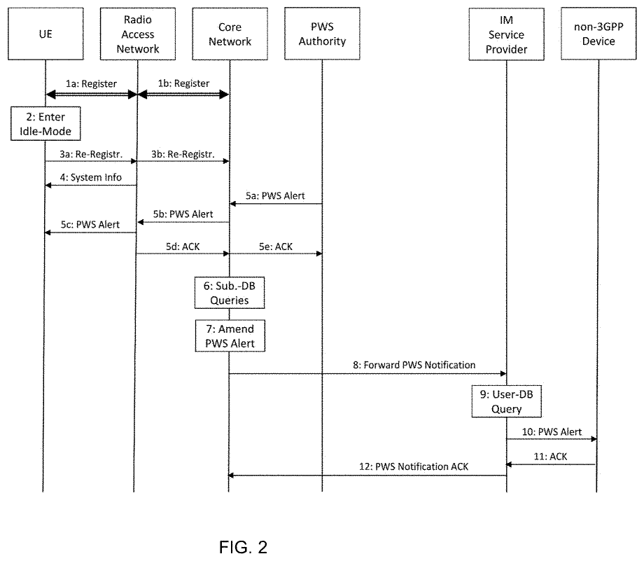

FIG. 2 is a message flow chart illustrating a sequence of messages for implementing one aspect of the invention.

For illustrating the invention, the following situation is described. A user has a subscription to a mobile network operator and an account for her favourite instant messaging service. Since her subscription includes a mobile data plan, the most frequently used application on her smartphone is the instant messaging app in order to stay in contact with her friends and family. She subscribes to a public warning forwarding service offered by her serving mobile operator by registering her instant messaging user ID and gives her consent to the instant messaging service provider to receive forwarded public warning notifications from her home operator via instant messaging.

Coming home late her smartphone almost run out of battery and she leaves it in the corridor in a charging cradle. She watches TV on the smartTV in her living room. Since she often chats with friends while watching her favourite series, she has installed the same instant messaging app on the smartTV as on her cellular phone.

A forest fire breaks out near her home. The authorities send out a corresponding public warning notification (“Large Fire in Riverside State Park—Stay inside, keep doors and windows closed.”) via the cellular public warning system. Operators forward the public warning notification via system information cell broadcast via all base stations in the affected area. Her home operator generates a list of all subscribers whose user equipment is registered in affected tracking areas. Therefore, the list contains subscribers, that possibly received the notification already via public warning system. There is no mechanism to receive an acknowledge for the reception of a public warning notification. Therefore, the list gives only an indication who should receive the public warning notification and not who actually received the notification or even less who has read the notification.

The list of potential recipients of a public warning notification is aligned with a list of subscribers to the inventive public warning notification forwarding service. The ID (IMSI, MSISDN, costumer ID, etc.) of the user in this embodiment is in these two lists. Therefore, the operator forwards the public warning notification to the registered third-party instant messaging service provider. In this embodiment the notification is coded in extensible markup language (XML) and sent to the instant messaging service provider in an application programming interface (API) provided for this purpose. An example for a forwarded PWS notification is shown below.

<?xml version=“1.0” encoding=“UTF-8” ?>
<PublicWarningSystem>

<HEAD>

<mcc>310</mcc>
<mnc>260</mnc>
<network>T-Mobile</network>
<address>jane.doe@thesocialnetwork.com</address>
<msisdn>+1xxxxxxxx398</msisdn>

</HEAD>
<notification>

<serial>8326938347903</serial>
<messageid>0203</messageid>
<DataCodingScheme>UTF-8</DataCodingScheme>
<PageParameter>1</PageParameter>
<date>20180803</date>
<time>20:04:13</time>
<location>47.809931,−117.584501
47.715511,−117.451106</location>
<MessageContent>Large-Scale Fire in Riverside State Park --

Stay inside and keep doors and windows closed.</MessageContent>

<signature>4f4ca3d5 d68ba7cc 0a1208c9 c61e9c5d</signature>

</notification>

</PublicWarningSystem>

In the header of the notification the operator with mobile country code (MCC), mobile network code (MNC), and network name may be listed. The mobile subscriber ISDN number (MSISDN) of the subscription used for the phone registered in the affected area and the ID for the instant messaging service of the user may also be provided.

The instant messaging service provider receives the PWS notification via an API and authorizes the forwarding. If the database look-up confirms user consent to receive PWS notifications by this provider originally addressed to the given MSISDN, the notification is forwarded to the user. Although the API might be secured, and the mobile operator should be authenticated via the API, optionally the instant messaging service provider might check the digital signature of the notification itself (signed by the origin authority) not to forward a false notification. It is beneficial to add the origin of the notification. The instant message to the user could look like this:

Public Warning System Notification
The following public warning was sent to your phone (++1xxxxxxxx398):
Large Fire in Riverside State Park -- Stay inside, keep doors and windows
closed.

The user in this embodiment would not notice the warning message on her phone while watching TV. Though, the instant message with the forwarded PWS notification is displayed on her smartTV and she will get informed about the emergency situation. An example message flow is depicted in FIG. 2.

The steps shown in FIG. 2 are as follows.

1: The UE register itself to the network. With the registration the UE enters the RRC-CONNECTED Mode.

2: The UE enters the RRC-IDLE Mode.

3: If the UE enters a new tracking area or after a configured period of time in the same tracking area, the UE performs a re-registration with same or new tracking area.

4: In RRC-IDLE mode the UE listens to the system information cell broadcast.

5a: The PWS authority sends a PWS alert message to the operators core network.

5b: The core network initiates the PWS notification via Cell Broadcast Service (CBS).

5c: The base stations in the affected tracking area broadcast the PWS notification via system information broadcast.

5d: The PWS alert message may be acknowledged to the cell broadcast centre (CBC) in the core network.

5e: The cell broadcast entity (CBE) may acknowledge the PWS alert to the PWS authority.

6: A core network entity (e.g. CBC) queries the subscriber database via a unified data management function (UDM), which UEs are registered in affected tracking areas and compares the result with a second database query, which users of these UEs are subscribed to the PWS notification forward service.

7: The PWS notification is amended in a form that it is aligned with the API of the third-party instant messaging service provider and additional information (e.g. the MSISDN allocated to the notified UE). Forwarded PWS notifications are addressed to the registered user IDs of the IM Service.

8: The amended PWS notifications are forwarded to one or more third party IM or social network services e.g. via dedicated APIs.

9: The third-party service authorizes the forward notification via user database query. User consent and preferences are stored in the data repository.

10: The PWS notification is send to one or more devices of addressed users via the third-party service.

11: The non-3GPP devices acknowledge the reception of the PWS notification.

12: The third-party service may acknowledge the successful reception of the forwarded PWS notifications.

A second embodiment is similar to the first one, but in this scenario the UE that receives the PWS notification is not in the same region as the non-3GPP device that receives the forwarded PWS notification. This could happen e.g. because a user leaves her UE accidently or on purpose at home while she is travelling or at work. The user receives the forwarded PWS notification on another UE or one or more non-3GPP devices via Instant Messaging Service in an area, that is not affected by the emergency situation.

Public Warning System Notification
The following public warning was sent to your phone (+1xxxxxxxx398):
Large Fire in Riverside State Park -- Stay inside, keep doors and windows
closed.

Since in the amended PWS notification it is clearly said to which UE the PWS notification has been sent to originally and what area is affected by the emergency situation, she is informed that she is currently not in the affected area. The public warning notification is still relevant since her home is within the affected area and she might want to contact friends or neighbours in order to take precautions.

A third embodiment is similar to the first one. The PWS notification is not forwarded via an instant messaging service (as in the first two embodiments), but with a messaging service within the local area network (LAN) in the user's home. In this embodiment the UE can be configured to forward PWS notifications as instant messages via LAN (e.g. with NetBIOS protocol) to one or more non-3GPP devices in the same local area network. The devices in a home environment can be addressed with the internet protocol (IP) address (e.g. 10.10.10.10), a broadcast address of the local area network (e.g. 10.10.10.255) or via the computer name. Computer names can be resolved to IP addresses with the NetBIOS protocol. The NetBIOS protocol is implemented in many devices as laptop computers, desktop computers, and embedded systems like SmartTVs or SmartTV-sticks. If a configured UE that is connected to a mobile network and in parallel to a local area IP network receives a PWS notification, it can forward the message unchanged or with amendments as in the first two embodiments to the non-3GPP devices connected to the same LAN. Commonly all devices connected to the same LAN are within the affected area. Devices in a local area network can communicate without involvement of external services or protocols.

1. A method of distributing a public warning message to a subscriber of a cellular communications system, the method comprising:
determining a geographical location of a cellular device associated with a subscriber;
storing in a database information connecting the cellular device associated with the subscriber to at least one messaging service receivable by a device other than the cellular device; and
in the event that a public warning message is to be broadcast to the geographical location in which the cellular device of the subscriber is located, transmitting a warning message to the subscriber using the at least one messaging service to the device other than the cellular device.

2. The method according to claim 1, wherein the warning message transmitted using the messaging service includes details about the public waning message and an identification of the cellular device.

3. The method according to claim 1, wherein the warning message transmitted using the messaging service includes an indication that the cellular device of the subscriber is in the area in which the public warning message has been broadcast.

4. The method according to claim 1, wherein the warning message is transmitted using the messaging service only if it is determined that the subscriber is currently using a device to which the messaging service can provide a connection.

5. The method according to claim 1, wherein the public warning message is broadcast by a mobile network operator and the messaging service authenticates the mobile network operator before transmitting the warning message to the subscriber.

6. The method according to claim 1, wherein the messaging service is a non-3GPP third party messaging service.

7. The method according to claim 1, wherein the messaging service is provided by a mobile network operator.

8. A method of distributing a public warning message, the method comprising
broadcasting by a public land mobile network one or more messages in a pre-defined distribution area, and in parallel
determining which user equipment, UE, devices are registered in a core network in a location that at least partly overlaps with the distribution area,
determining one or more subscribers associated with the determined UE devices, looking-up by the core network one or more alternative communication addresses associated with the one or more subscribers which are not alternative addresses of the determined UE devices in one or more alternative communication networks, and
providing the one or more messages addressed to the one or more alternative communication addresses in the one or more alternative communication networks for delivery to one or more further devices.

9. A method of distributing a public warning message, the method comprising:
receiving by a user equipment device a broadcast public warning message;
forwarding the received public warning message via a local area network to one or more devices previously registered with the user equipment device for receiving forwarded public warning messages.

10. The method according to claim 2, wherein the warning message transmitted using the messaging service includes an indication that the cellular device of the subscriber is in the area in which the public warning massage has been broadcast.

11. The method according to claim 2, wherein the warning message is transmitted using the messaging service only if it is determined that the subscriber is currently using a device to which the messaging service can provide a connection.

12. The method according to claim 2, wherein the public warning message is broadcast by a mobile network operator and the messaging service authenticates the mobile network operator before transmitting the warning message to the subscriber.

13. The method according to claim 2, wherein the messaging service is a non-3GPP third party messaging service.

14. The method according to claim 2, wherein the messaging service is provided by a mobile network operator.
